(19) United States
(12) Patent Application Publication
(10) Pub. No.: US 2017/0157853 A1
(43) Pub. Date: Jun. 8, 2017

(54) FUNERAL URN AND METHODS OF PRODUCING FUNERAL URNS

(71) Applicant: Lauren Gallinaro, Brooklyn, NY (US)

(72) Inventor: Lauren Gallinaro, Brooklyn, NY (US)

(21) Appl. No.: 15/368,085

(22) Filed: Dec. 2, 2016

Related U.S. Application Data
(60) Provisional application No. 62/262,206, filed on Dec. 2, 2015.

(51) Int. Cl. B29C 67/00; B05D 1/18; B33Y 10/00; A01G 9/10; B33Y 50/02; B33Y 70/00; B33Y 80/00; A01G 9/02; B05D 1/28; B33Y 40/00

(52) U.S. Cl. CPC B29C 67/0081; B29C 67/0088; B05D 1/28; B05D 1/18; B33Y 10/00; B33Y 40/00; B33Y 50/02; B33Y 70/00; B33Y 80/00; A01G 9/021; A01G 9/102; A01G 9/1086; B29K 2995/006; B29K 2105/251

(57) ABSTRACT

A process for low waste production of funerary urns includes the steps of providing cremain as a powder having a particulate size of between approximately 0.1 micron and approximately 1000 microns, providing composite material as a powder having a particulate size of between approximately 0.1 micron and approximately 1000 microns, placing the cremain and composite material into an input container of a 3D printer, wherein the composite material and the cremain are mixed to have at least approximately 20% by volume of the cremain, generating a 3D printer input file corresponding to at least one urn shape, and, based upon the input 3D printer input file, printing the at least one urn shape from the mixture with the 3D printer. The volume of the cremain can be as much as approximately 50%.

### CROSS-REFERENCE TO RELATED APPLICATIONS

This application claims the priority, under 35 U.S.C. §119, of copending U.S. Provisional Patent Application No. 62/262,206, filed Dec. 2, 2015; the prior application is herewith incorporated by reference herein in its entirety.

### STATEMENT REGARDING FEDERALLY SPONSORED RESEARCH OR DEVELOPMENT

Not Applicable

### FIELD OF THE INVENTION

The present systems, apparatuses, and methods lie in the field of funerary urns, devices, and memorials, in addition to three-dimensional printing/additive manufacturing, ecological design, and industrial design of same. The present disclosure relates to systems and methods for designing, fabricating, and using cremated remains and composite material in combination to form a type of decorative memorial or biodegradable burial urn.

### BACKGROUND OF THE INVENTION

While cremation has been popular in parts of the world for centuries, it is only now just gaining traction as the soon-to-be most popular choice for internment of the deceased in the West. The cremains or ashes are commonly either spread out, such as at sea, or kept in an urn. Traditionally, an urn is any funerary receptacle charged with the responsibility of holding or containing the ashes of the deceased, be it an animal, pet, or human being.

There are a number of precedents for customizable memorial and burial urns for cremains. They range from photorealistic containers to configurable designs that accommodate anything from the ashes to memorial items. There exists several patents for the apparatus and method of burying a container holding human or pet cremains that eventually disintegrate either in water and/or render seed/plant growth. Recently there have been several patents for the combination of cremains, and a material like glass to capture both the ashes of the deceased as well as, but not limited to, a personal memento or mark to memorialize the deceased.

U.S. Pat. No. 5,774,958 to Casimir discloses a dissolvable urn for the disposal of cremated remains.

U.S. Pat. No. 6,516,501 to Vazquez-Perez discloses an urn comprising a series of pod-like containers made of compressed materials, designed to function as cinerary urns; and eventually producing a living monument.

U.S. Pat. No. 7,191,498 to Fischer discloses cremation urns for storing and displaying cremated remains, including methods of forming such devices.

U.S. Pat. No. 8,364,549 to Sell relates to the products and services for funeral home general items along with the customization of those items. The customization can be done with the computer or through an interface with the Internet, such as a dedicated web site. Sell relates to the shape and accessories for an urn, engravings, material choices, and urn structure.

U.S. Patent Pub. No. 2012/0146258 to Kim et al. discloses a method of making crystals from remains, including the steps of: recovering remains; pulverizing the remains to form bone powder; mixing the bone powder with a natural mineral to form seeds; putting the seeds into a calcinator and then leaving them at a temperature to form solid crystals; and cooling and then surface-treating the solid crystals.

U.S. Pat. No. 8,196,274 to Heckenbach discloses a single unit crematory urn in the shape of a sports article, wherein the cremated remains of humans or pets are disposed within the sports shaped article.

U.S. Pat. No. 6,571,439 to Sens discloses a cinerary urn device for holding and displaying cremated remains of a loved one. The cinerary urn device includes a housing for receiving cremated remains.

U.S. Pat. No. 7,866,013 to Laurens discloses a type of urn having an opening for water and an opening for the discharge of the water with powdery mortal remains. Ashes are introduced in the urn, in the form of a body comprising powdery ashes and a binder, where the binder is selected from a water-soluble binder and an agent that disintegrates under the influence of water. The mortal remains are introduced into the earth under the influence of (rain) water. Laurens also relates to a method for making such a body.

U.S. Pat. No. 5,636,418 to Vail, III et al. discloses articles of manufacture referred to as environmentally degradable urns. Such urns are comprised of chemically and/or biologically and/or physically degradable materials manufactured to provide sealed geometric cavities suitable for the initial deposit of ashes following the cremation of human remains.

U.S. Pat. No. 6,200,507 to Dennis discloses a device where cremated ash remains of a deceased individual may be combined in a suitable resin material to fill a statuary urn or to fill a shell as a memorial to the decedent. The sculptural urn or shell may be molded of a resin in any desired shape. By use of a suitable resin with additives, the urn or shell may be molded with surface finishes such as marble, bronze, metal, ceramic, stone, and wood. The same resin may be mixed with the cremated ashes to fill the shell and to top off any remaining space. After the material cures, the resulting sculpture may be place in a garden, shrine, or elsewhere as a permanent memorial.

U.S. Pat. No. 5,379,499 to Jackson discloses a cremation urn having a first container adapted for receiving the cremated remains of a deceased person, and a second, concealed container for storing memorabilia.

U.S. Pat. No. 9,168,573 to Hojaji discloses a product comprising a combination of a plurality of recovered materials and at least one precursor material, an interaction between biomass, and at least one fluid providing the plurality of recovered materials. The biomass is of animal or human origin, the at least one fluid in interaction with the biomass provides at least one of degradation of a plurality of organic molecules comprised by the biomass, and breakage of a plurality of protein bonds comprised by the biomass, and the combination of the plurality of recovered materials and the at least one precursor material forms the product into a solid object.

Thus, a need exists to overcome the problems with the prior art systems, designs, and processes as discussed above.

### SUMMARY OF THE INVENTION

The systems, apparatuses, and methods described provide funerary devices and systems and method for creating funerary devices that overcome the hereinafore-mentioned disadvantages of the heretofore-known devices and methods of this general type and that provide such features by incurring as little waste as possible and do so by using the cremains as one of the major sources of fabrication material. The funerary devices and systems described herein can be manufactured to be both an object of permanence, as well as a biodegradable urn that is capable of rendering seed growth, simply by customizing the type of second material composite the ashes will be mixed with before being set by the binder, as well as the binder itself. Further, the final form of the urn is customizable through software that is able to accommodate design input as well as empirical measurement of cremain volume and iteration count to produce a unique or set of urns that are truly different for each individual. The systems, apparatuses, and methods described herein are referred to as “Oroboro.”

Provided are systems and processes for designing, fabricating, and using a funeral urn composed of the deceased's ashes, which may be called a “Radix element,” for the purpose of repurposing and/or preserving the ashes and memory of the deceased. The urn is rendered in a matrix of (1) the ashes/particulate of the deceased, (2) a second composite, and (3) a binding agent. The second composite can be either biodegradable and include seeds for plant growth if the urn is to be buried, or plastic/or metal based particulate if the urn is to be a decorative memorial implement. The binding agent may be composed of a biodegradable glue if the urn is to be buried, as well as a resin if the urn's purpose is purely decorative. The fabrication process may include 3D printing of the element into the designed form, as well as casting of the element, which would also require the 3D printed or traditional manufacture of the molds.

As a system, Oroboro seeks to solve several problems. With global mortality rates falling over the century, it is important to note that death becomes a more isolated an individualized threat in low mortality cultures. As such, history has proven that, as with Western funerary customs, practices and rituals have become extravagant, incongruous with respect to tradition or religious custom, and wasteful.

Oroboro mitigates several of the symptoms and effects of this trend. Not only are the systems, apparatuses, and methods designed to cut down on wasteful burial practices (such as the thousands of tons of embalming fluid, concrete, wood and other materials used in body preparation and gravesite and casket construction), but also to reduce the scale and cost of manufacturing of containers for remains and, inevitably, the associated material waste. Such waste includes material cut-offs, scraps, and particles. Further, Oroboro offers an alternative for diminishing available space, especially in urban and some suburban cemeteries around the U.S. Oroboro burial urns are not restricted to having to be buried in cemeteries and permanent Oroboro urns require no burial. Finally, for the biodegradable urns, Oroboro aims to resolve existential anxieties of death and impermanence by promising an alternative that can potentially result in a “life after death,” and without the environmentally destructive practices that have evolved in contemporary funeral culture. It is also important to note that some individuals may not want a biodegradable urn, but may still want to choose an alternative that is less wasteful than the current burial and urn production methods that currently exist on the market. Keepsake urns meet this need as they employ the process of Oroboro to derive an urn comprised of the cremains; however, the supplementary composite material is not biodegradable.

The inventive concepts disclosed serve a similar function to urns and other containers of funerary ashes, however, the critical difference is that Oroboro urns rely on the ash as a significant part of the manufacturing material. This characteristic mitigates the problem of excessive waste in the burial and fabrication of funerary accessories and implements. Instead of using additional material, which requires derivative manufacturing to merely hold or contain the ashes, the Oroboro process utilizes the ashes and raw unfinished particulate to fabricate the contents as the container. Additionally, the urn can be fabricated to decompose and support plant growth after burial in the ground, eliminating the need to inter the deceased or urn in the already limited space of a cemetery. This feature helps to alleviate the grief that comes with the permanence of death of a loved one, by providing the opportunity for friends and family members to “plant” their loved ones. For some customers, having a permanent memento is important, so Oroboro urns can also be made as permanent memorial sculptures, eliminating the need to inter the deceased, cutting down on the material waste of traditional urn fabrication, and still providing a memento of the deceased for friends and family to hold onto.

The fabrication process relies on two types of 3D printing to produce the customized urn, as well as traditional mold making/casting techniques. Aside from the ash particulate, there exists an opportunity to customize the overall composition of the Oroboro urn.

Customization of the urn's form is computer generated by a combination of domain specific (modeling) software and custom built software that interfaces with the output of the modeling software. The type of form customization may include, but is not limited to, overall form generation, surface ornament/treatment, photorealistic modeling or ornament/decoration, embossed or engraved text, and/or perforations for aiding decomposition of a bio urn as well as decoration. Digital customization also includes the calculation of available material and the ability to portion the cremain composite for sets of burial and/or keepsake urns. Further customization may also include the type of seeds embedded in the biodegradable urn.

In the case of fabrication of a bio urn, the second composite can include, but is not limited to, agricultural feedstock waste, clays, salts, corn byproduct, organic particulate, and other like products. Once particulate is combined, an organic binder can be applied, either to create a paste that is extruded through “Fused Deposition Modeling” or FDM 3D printing, or cast in a mold. Alternatively, the binder can be laid down by binder jetting, otherwise known as powder printing, layer-by-layer, as determined by a computer program that has sliced a 3D-computer model of the urn. The biodegradable binder may include, but is not limited to, an agent such as cornstarch or dextrin-based, flour-based, and/or corn-syrup-based glue, and/or gelatin-based, salt-based, and/or potassium-based adhesive.

In the case of fabricating a keepsake urn (i.e., a permanent device), the second composite can include, but is not limited to, clays, wood powder, plastics, metal powder, and other like inorganic composites. Once the particulate is combined, a chemical binder, such as cement can be applied prematurely for FDM-printed or cast urns. The chemical binder can also be applied after each layer of dry particulate is applied in the powder printing process.

The finishing process for both includes a glaze to protect the particulate from becoming dislodged onto any foreign body that may come into contact with the Oroboro urn. The biodegradable urn receives a glaze that is compostable and poses no harm to the surrounding soil or seeds; it may be protein based and/or hydrophilic. The keepsake urn may be finished by a number of glazes including but not limited to ceramic glaze, stains, and other chemical sealers that can be safely handled by humans once fully cured.

For biodegradable urns, the Oroboro process concludes with burial. While the urn is shelf stable for at least eighteen (18) months, it is buried no deeper than a specified depth that depends upon the type of seed chosen before fabrication, as measured from the top of the urn where embedded seed deposition exists.

With the foregoing and other objects in view, there is provided, a process for low waste production of funerary urns includes the steps of providing cremain as a powder having a particulate size of between approximately 0.1 micron and approximately 1000 microns, providing composite material as a powder having a particulate size of between approximately 0.1 micron and approximately 1000 microns, placing the cremain and composite material into an input container of a 3D printer, wherein the composite material and the cremain are mixed to have at least approximately 20% by volume of the cremain, generating a 3D printer input file corresponding to at least one urn shape, and, based upon the input 3D printer input file, printing the at least one urn shape from the mixture with the 3D printer.

In accordance with another mode, the cremain is approximately thirty percent (30%) of the volume of the mixture.

In accordance with a further mode, the cremain is approximately forty percent (40%) of the volume of the mixture.

In accordance with an added mode, the cremain is approximately forty-five percent (45%) of the volume of the mixture.

In accordance with an additional mode, the cremain is approximately fifty percent (50%) of the volume of the mixture.

In accordance with yet another mode, the 3D printer comprises a wet paste extrusion system having a feed line, the input container as a hopper in which is disposed the mixture of the composite material and the cremain and binder, and that is fluidically connected to the feed line, and a print head fluidically connected to the hopper through the feed line and carrying out the printing of the at least one urn shape.

In accordance with yet a further mode, the cremain is a first powder having a particulate size of between approximately 0.1 micron and approximately 200 microns, the composite material comprises binder and a second powder having a particulate size of between approximately 0.1 micron and approximately 200 microns, and the 3D printer comprises a dry powder printing system having the input container as a powder supply chamber in which is disposed the cremain and the second powder and a printer cartridge in which is disposed the binder.

In accordance with yet an added mode, the composite material comprises a biodegradable organic material and the at least one urn printed is biodegradable.

In accordance with yet an additional mode, the organic material comprises dextrin-based glue.

In accordance with again another mode, there is provided the step of adding at least one seed to the upper two inches of the urn.

In accordance with again a further mode, there is provided the step of burying the urn no deeper than four inches below the surface of the ground to permit growth of the at least one seed.

In accordance with again an added mode, the composite material is selected from a material comprising at least one of clay, wood powder, plastic powder, silica or sand, stone particulate, and/or metal powder and the urn produced is a permanent keepsake.

In accordance with again an additional mode, the binder comprises a chemical binder selected from at least one of resin, collagen, casein, wax-based cement, and/or wax-based adhesive and the urn produced is a permanent keepsake.

In accordance with still another mode, there is provided the step of coating at least an outside surface of the urn with a glaze.

In accordance with still a further mode, the glaze is at least one of protein based and/or hydrophilic.

In accordance with still an added mode, the glaze comprises at least one of ceramic glaze and/or a stain.

In accordance with still an additional mode, there is provided the step of selecting at least one urn shape from a plurality of urn shapes.

In accordance with still an additional mode, there is provided the step of selecting a plurality of urn shapes and repeating the generating, inputting, and printing steps for each urn shape.

In accordance with still an additional mode, there are provided the steps of selecting a plurality of urn shapes, selecting the number of editions of each urn shape to be fabricated, and repeating the generating, inputting, and printing steps for each edition of each urn shape.

In accordance with a concomitant mode, the urn is one of a pre-designed form, a custom-designed form, and a photorealistic form.

Although the systems, apparatuses, and methods are illustrated and described herein as embodied in funerary devices and systems and method for creating funerary devices, it is, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems, apparatuses, and methods.

Additional advantages and other features characteristic of the systems, apparatuses, and methods will be set forth in the detailed description that follows and may be apparent from the detailed description or may be learned by practice of exemplary embodiments. Still other advantages of the systems, apparatuses, and methods may be realized by any of the instrumentalities, methods, or combinations particularly pointed out in the claims.

Other features that are considered as characteristic for the systems, apparatuses, and methods are set forth in the appended claims. As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one of ordinary skill in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the systems, apparatuses, and methods of the invention that are regarded as novel, it is believed that the systems, apparatuses, and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems, apparatuses, and methods. Advantages of embodiments of the systems, apparatuses, and methods will be apparent from the following detailed description of the exemplary embodiments thereof, which description should be considered in conjunction with the accompanying drawings in which:

FIG. 1 is a process flow diagram of an exemplary process detailing how each permutation of the product arrives at its final form;

FIG. 2 is a process flow diagram of an exemplary process detailing a parametric design process for generating the data/form for the digital model of the urn;

FIG. 3 is a process flow diagram of an exemplary method for deriving a digital model for the urn or mold to be printed;

FIG. 4 is a diagrammatic representation of an exemplary embodiment of a software interface employed to customize input and generate metrics and designs for the digital model of the urn.

FIG. 5 is a cross-sectional view of an exemplary embodiment of a fused deposition modeling or 3D-FDM printing process for both biodegradable and keepsake urns;

FIG. 6 is an axonometric perspective view of an exemplary embodiment of a binder jetting/powder printer for printing both biodegradable and keepsake urns;

FIG. 6A is an axonometric cross-sectional view of the binder jetting/powder printer of FIG. 6;

FIG. 7 is a perspective view of an exemplary embodiment of a biodegradable urn and a portion of the urn featuring embedded seeds; and

FIG. 8 is a fragmentary, cross-sectional depiction of an exemplary embodiment of a burial process for the biodegradable urn.

### DETAILED DESCRIPTION OF THE EMBODIMENTS

As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one skilled in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the features of the systems, apparatuses, and methods that are regarded as novel, it is believed that the systems, apparatuses, and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the systems, apparatuses, and methods will not be described in detail or will be omitted so as not to obscure the relevant details of the systems, apparatuses, and methods.

Before the systems, apparatuses, and methods are disclosed and described, it is to be understood that the terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact (e.g., directly coupled). However, “coupled” may also mean that two or more elements are not in direct contact with each other, but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

It will be appreciated that embodiments of the systems, apparatuses, and methods described herein may be comprised of one or more conventional processors and unique stored program instructions that control the one or more processors to implement, in conjunction with certain non-processor circuits and other elements, some, most, or all of the functions of the devices and methods described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system or programmable device. A “program,” “software,” “application,” “computer program,” or “software application” may include a subroutine, a function, a procedure, an object method, an object implementation, an executable application, an applet, a servlet, a source code, an object code, any computer language logic, a shared library/dynamic load library and/or other sequence of instructions designed for execution on a computer system.

Herein various embodiments of the systems, apparatuses, and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

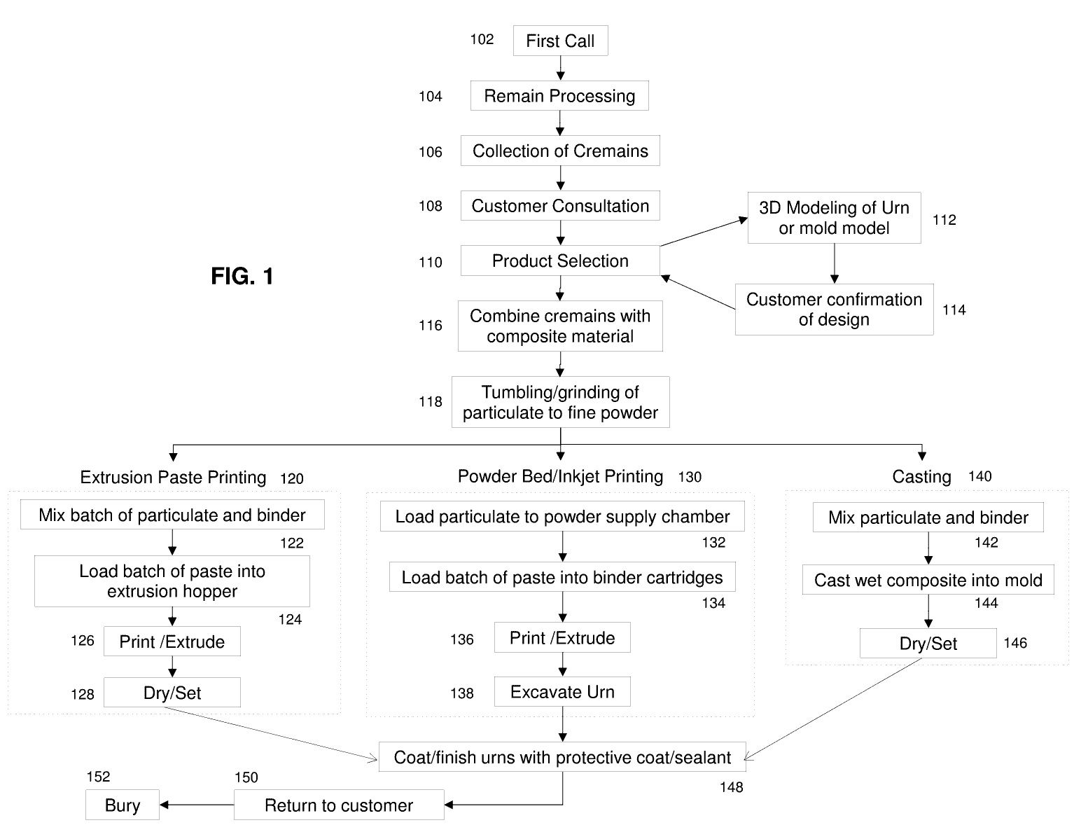

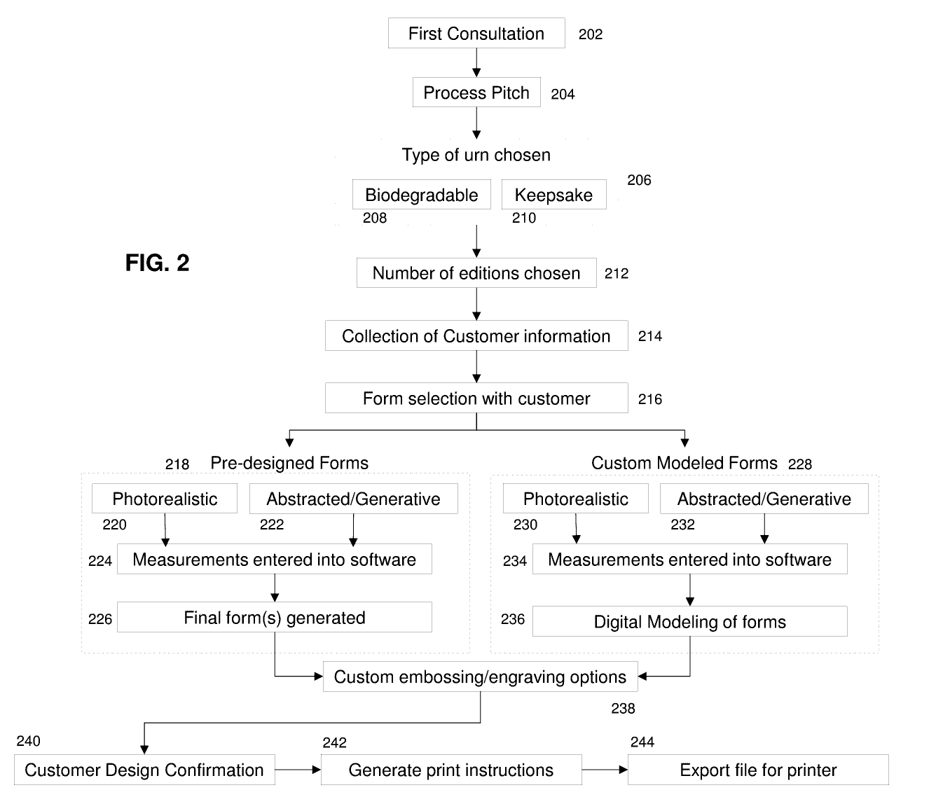

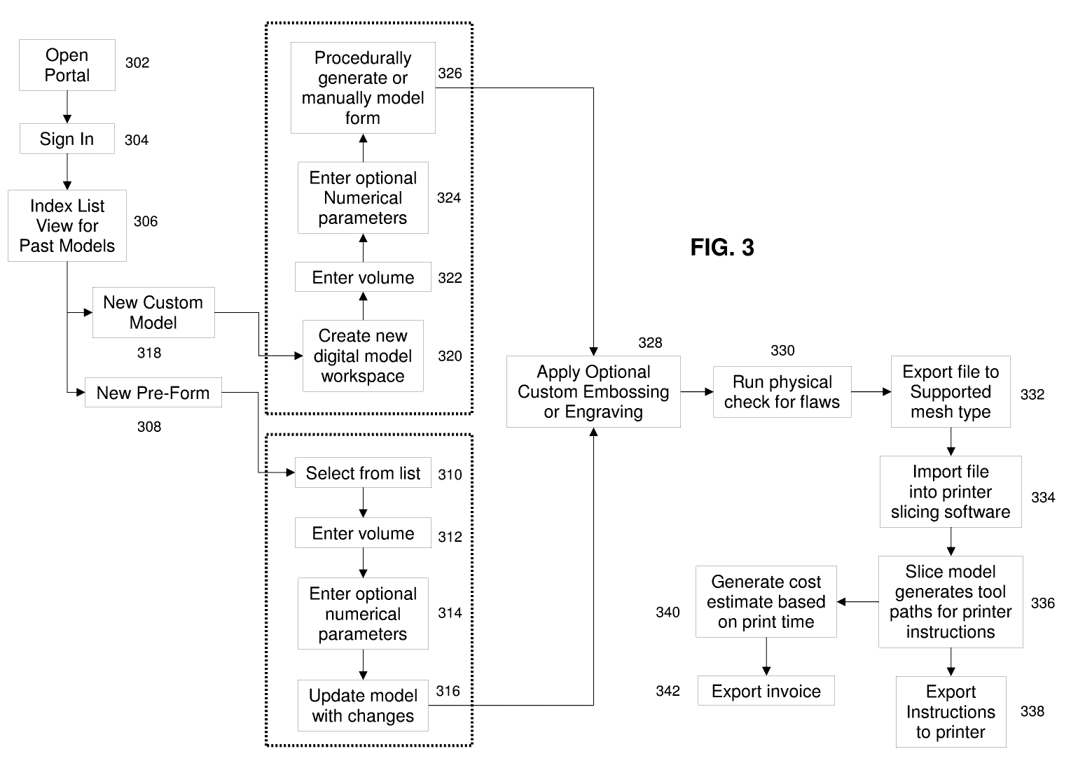

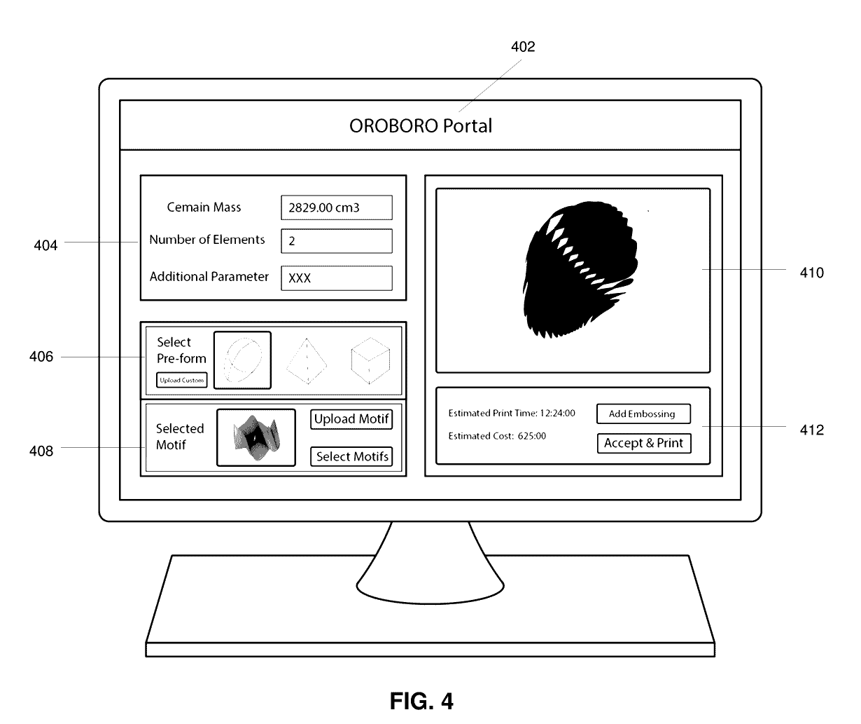

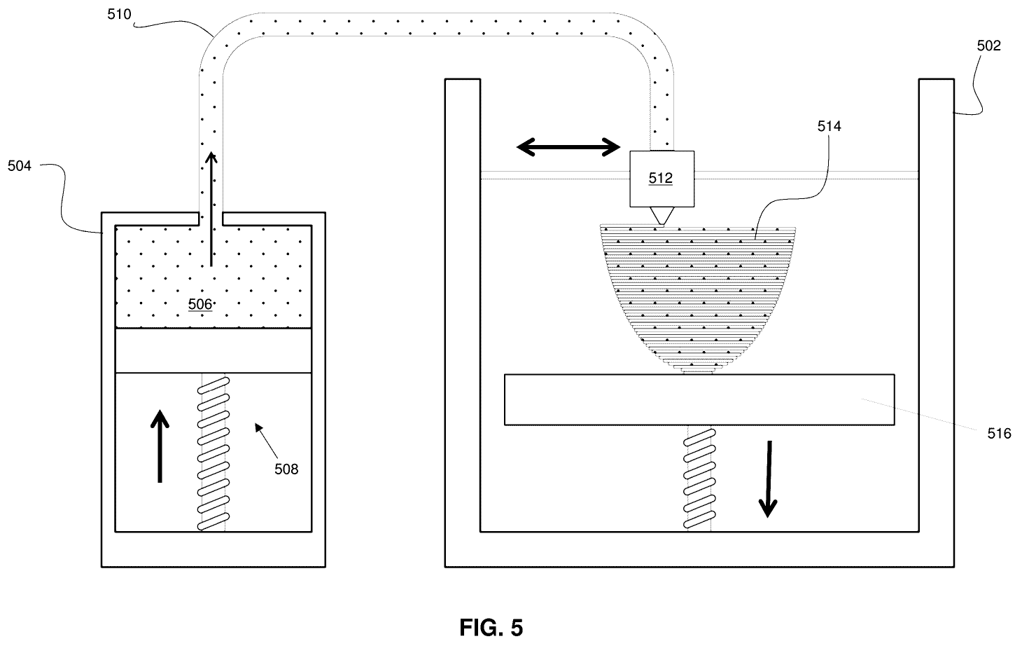

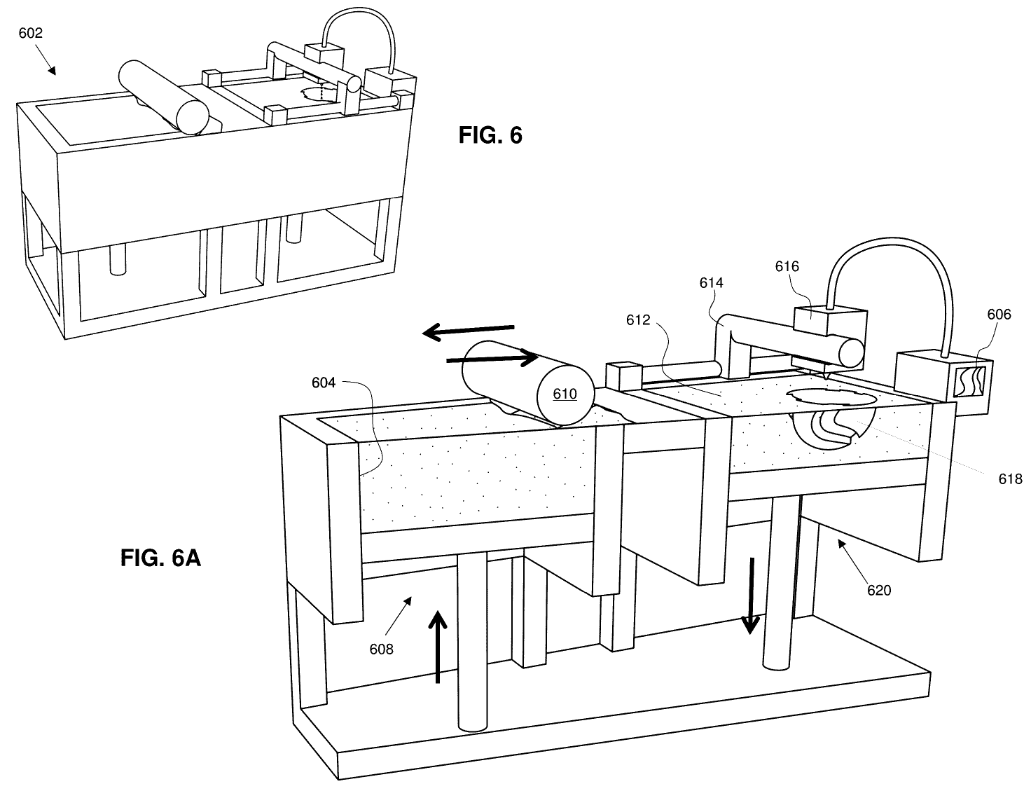

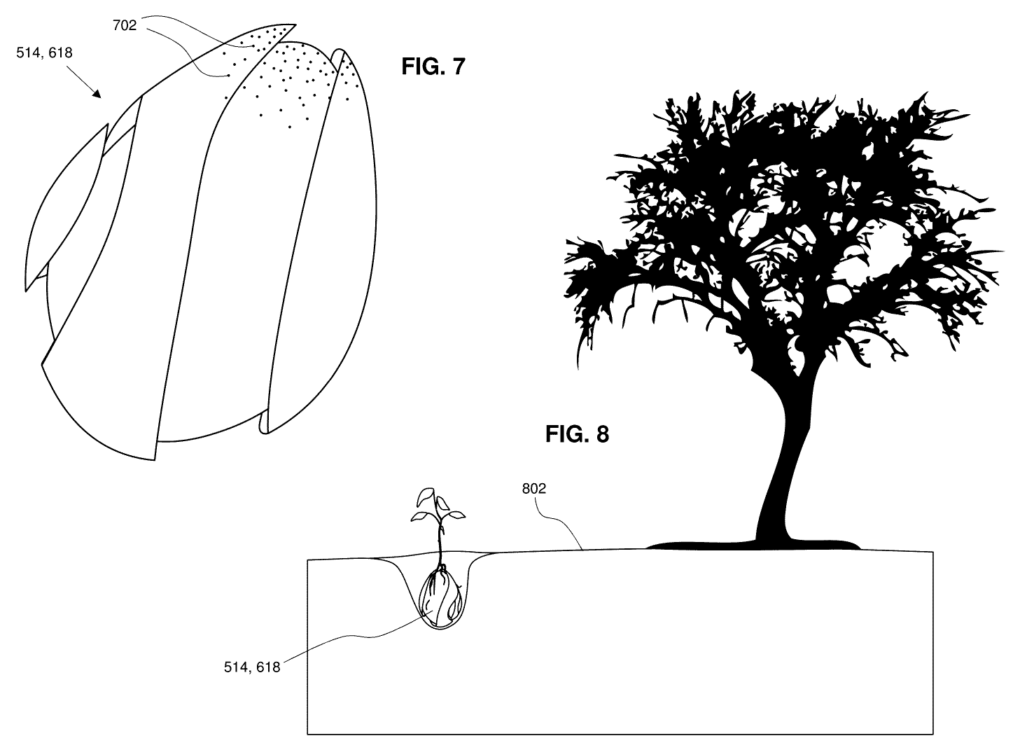

Described now are exemplary embodiments. The drawings depict the flow of the fabrication and design process for the conception and production of Oroboro urns, as well as physical fabrication and makeup of the urn. FIG. 1 illustrates the scope and combinatorial nature of the fabrication process and how it flows in parallel/conjunction with the design process. While FIG. 1 demonstrates the entire process from start to finish, FIG. 2 is related and expands on the details of the overall design process. FIGS. 3 and 4 are supplementary to FIG. 2 as it shows how a technician facilitates the customization and modeling of the user's desired design. FIGS. 5, 6, and 6A illustrate fabrication using a binder jetting/powder printer and extrusion fabrication of a custom Oroboro urn that is rendered by the software process documented in FIGS. 3 and 4. FIGS. 7 and 8 are specifically related to the composition and final planting process of the biodegradable urn 102.

Referring now to the figures of the drawings in detail and first, particularly to FIG. 1, there is shown a first exemplary embodiment of a process that is the role of a funeral home or approved vendors. The first step in the fabrication of the Oroboro urn begins with a first call 102, which is known across the funeral industry as the first step in the process, or the “first call” to the funeral home after the deceased has been pronounced dead. The body must be collected by either a medical professional or a funeral home depending on funerary laws of the region and transferred to a facility for processing 104. At this stage, traditionally, the body will be cremated in an oven or via Alkaline Hydrolysis, which submerges and dissolves the body in a basic heated solution, to render the ash particulate cremains that will be used to fabricate both types of urns. The particulate rendered from Alkaline hydrolysis measures approximately as much, if not slightly more in volume than traditional cremation. Ultimately, the resulting particulate that can be expected is around 10 to 13 cups, or about 1 cup per 10 to 15 pounds of body weight of the deceased at the time of death. Once the remains have been processed, they must be transferred back to the customer or to a funeral home/facility if they are licensed to fabricate Oroboro urns 106. At this point, customer consultation takes place with an approved vendor, where a professional or technician trained or familiar with the fabrication process conducts a series of questions. The purpose of question intake is to determine if the customer's desires for the end-of-life use case for the ashes align with the different cases that Oroboro urns facilitate 108. Such cases include, but are not limited to, a desire to contribute as little waste as possible to the environment, mitigating the exorbitant cost associated with traditional burials, deriving customized and personalized urn artifacts from the remains of the deceased, and rendering plant growth to create a living memory of the deceased in the case of the biodegradable urn.

If the technician or funeral professional believes Oroboro would be an apt fit, the customer is informed of the Oroboro system and the tiered product line offerings to choose from. The customer can choose a biodegradable urn, a keepsake urn, or multiples of each kind. The number of different urn type combinations and iterations is only limited by the cremated particulate available. Once the type(s) and number of urns have been decided 110, the customer is then able to choose the shapes of the final product based on a set of pre-modeled forms, or opt to have a custom form modeled for them. These pre-modeled urns take the form of abstract geometry as well as photorealistic objects. Alternatively, the customer can opt for the production of custom models either to be 3D printed or cast from a 3D printed mold 112. Once the final model(s) have been completed and approved by the customer, the urn is ready to be fabricated. It is worth noting that steps 110 through 114 can also be completed while the deceased is living and making funeral arrangements in advance. They exist as sequential steps in FIG. 1 to illustrate the typical progression that a customer choosing an Oroboro urn may go through. Therefore, steps 110, 112, and 114 may occur before step 102, and are detailed further in FIG. 2.

Once the customer consultation and design process is complete, the next step is physical fabrication of the urn. The exact type of composite is another parameter or attribute that the customer chooses during the consultation. Each type requires a different composite makeup that is combined with the cremains. For biodegradable urns, the added composite includes, but is not limited to, agricultural feedstock waste, clays, salts, corn byproduct, organic particulate, and other like products. The binding agent is biodegradable, such as a dextrin-based glue or chemically similar mixture. The appropriate material composition for a biodegradable binder such as dextrin-based glue is three-parts dextrin to one-part water or soluble liquid, reduced over a rolling boil for approximately an hour. For keepsake urns, the added composite includes, but is not limited to, clays, wood powder, plastics, metal powder, and other like inorganic composites 116. Binders can take the form of anything from a biodegradable binder, like dextrin glue, to a resin, collagen, casein, or wax based cement, adhesive, or binder.

To ensure high fidelity final products, the composite particulate and the cremain particulate is tumbled and ground to measure between approximately 0.1 micron and approximately 1000 microns. The variation in particle size accounts for the different types of fabrication. For powder printing, the desired particulate size range is between approximately 0.1 micron and approximately 200 microns, whereas the FDM printing and casting processes can accommodate particulate measuring along an entire spectrum of approximately 0.1 micron to approximately 1000 microns. Further, the tumbling process ensures an even distribution of ash and composite particulate in the final mixture 118.

Once the particulate has been ground to the appropriate particle size, it is ready for printing or casting. Fused Deposition Modeling is a term for Extrusion Paste Printing 120, one of the types of printing employed to fabricate Oroboro urns. The machinery necessary to extrude the paste of the ash/composite particulate and binding agent is similar to the type of setup that incorporates a RepRap 3D FDM printer and a Structur3d Printing's Discov3ry paste extruder. The process requires a hopper or plunger to load wet ash particulate and a motor to drive the material through a feed leading to a print head. Finally, the print head should be able to operate and extrude paste on three axes, regardless of whether it is modeled after a traditional 3-axis RepRap. This is only one example of how an Oroboro urn may be printed; other models include, but are not limited to, Delta printers, 5-axis robotic arms, and similar implements that could easily be retrofitted. A technician trained in operating a 3D printer or extrusion printers first mixes, for example, approximately 1 part wet binder to 3 parts particulate 122 and loads the mixture into the hopper or plunger container 124. Depending on the size of the printing system and the Oroboro urn, multiple batches of paste may be mixed and loaded throughout the duration of the printing process. It is important to note that the paste can be stored in the hopper for approximately six (6) hours and is done so without exposure to air to prevent drying or clogging. The printer extrudes paste layer-by-layer as it reads instructions written in G-code or a similar language from the program used to import a digital model of the Oroboro urn 126. For biodegradable urns, the option to incorporate seeds to facilitate plant growth requires that the final batch include the seeds in question within the paste composite mixture. Perfect even distribution of seeds within the ash and composite matrix is not necessary, however, it is important for the seeds to be distributed throughout the top 1 to 2 inches of the urn. The Oroboro urn fabrication technician makes certain that the print head is able to accommodate the extrusion of the seeds. If not, the technician may need to install a nozzle with a large enough extrusion diameter to accommodate passage of the chosen seeds. Once the urn is finished printing, it is ready to dry and set 128 for approximately twenty-four (24) hours before the final coating process.

Alternatively, the Oroboro urn can be fabricated by employing a Powder Bed, otherwise known as Inkjet Printing 130. This type of printing requires the wet binding agent to be loaded into the printer, similar to a printer like a Z Corp powder printer, separately from the chamber that holds the dry particulate, and is explained in greater detail in FIG. 5. While the dry cremain and composite particulate are loaded into the powder supply chamber 132, the wet binder is loaded into the print head cartridge 134. Once the materials are loaded into the printer, a technician skilled in operating a powder printer loads the program responsible with interpreting the printing instructions from the model into tool paths that the print head follows. For each layer that is printed, a fresh layer of particulate is ejected from the powder supply chamber into the print bed chamber and spread evenly over the top. The print head then deposits a layer of binder until the entire urn has been printed 136. With powder printing, the urn must then be carefully removed from the mass of surrounding loose particulate with delicate instruments, including but not limited to, brushes, small picks, and airbrushes 138. Once the urn has been removed and cleaned, it must be handled with extreme care before the final coating process.

Aside from directly 3D printing the Oroboro urn, it can also be cast from a mold. The mold can be fabricated using traditional subtractive modeling/mold making techniques. Casting makes the most sense as a process if the chosen form of the Oroboro urn is not complicated (complicated models feature overhangs, undercuts, or difficult to reach interstitial spaces for which casting is not suited) and is to be duplicated many times. The mold making process also incorporates 3D printing using basic plastic, sandstone, or plaster printing powder/particulate to fabricate the pattern around which the mold would be cast. A skilled mold maker is able to take a 3D printed urn pattern and cast 140 the mold surrounding. Once the mold is fabricated, it is ready to receive the wet mixture of, for example, 1-part binder to 3-parts cremain composite particulate 142. The mixture is poured through the sprue or gate, an opening in the top of the mold, and set appropriately to remove air pockets or bubbles 144. After approximately 24 hours, the mold can be removed, and the urn left to dry 146 for approximately another 24 hours. The urn is then ready for finishing during the coating process.

The finishing process is a final fabrication step before presenting the Oroboro urn to the customer. Paste extrusion printed and cast urns require a basic protective coat to prevent surface particulate from becoming dislodged onto individuals who touch the dry urn. For biodegradable urns, this coating or glaze is compostable and poses no harm to the surrounding soil or seeds; it may be protein based and/or hydrophilic. A similar type of glaze might be casein protein, or a similar paste derived from dextrin or maltodextrin. For keepsake urns, the final coating includes ceramic glaze, stains, and other chemical sealers that can be safely handled by humans once fully cured. Both types of glazes or finishes could include applied natural and synthetic coloring. Such natural dyes include, but are not limited to, vegetable dyes, animal based dyes, and other plant or fungi based dyes. Such synthetic dyes or glazed include, but are not limited to, acid dyes, basic dyes, and other inorganic chemical based dyes. Such glazes include, but are not limited to, ash glaze, tin glaze, or glazes comprising of silica, calcium, sodium, and potassium. With respect to powder printing or binder jet printed urns, the finished product is not structurally stable out of the printer and must have a resin binding agent applied as soon as possible to prevent easy breakage 148. Such coatings can be applied by brush or submersion of the urn into the binding solution. Each urn should be given approximately twenty-four (24) hours to dry after the last coat.

The urn is finally ready to be returned to the customer 150. It can stand in for an urn during a religious or end of life ceremony. Additionally, biodegradable urns are ready for planting and burial 152. They are shelf stable for minimum of eighteen (18) months, and are buried no deeper than four (4) inches below the surface of the ground to permit growth of the embedded seeds.

Referring to FIG. 2, one of the defining features of the product is the customizable nature of its end state, which is facilitated by the parametric design process and generative form making software referenced in FIG. 3. Initiation of the design process is not actually dependent upon the physical availability of the ashes or cremains of the customer or deceased individual. The only empirical measurement that is used as a contributing design parameter in advance is the volume of ash available for printing, something that is easily estimable from the weight of the customer at the time of the design process. Any margin of error can be supplemented by the addition of the composite particulate that will make up the final particulate mixture. The design process begins with the first consultation, where a funeral director or technician familiar with the Oroboro process gauges customer interest 202. The process pitch then ensues, explaining to the customer that Oroboro is a zero-minimal waste urn that utilizes the cremain material of the deceased for approximately fifty percent (50%) of the total composition of the final product 204. In exemplary embodiments, the cremain material is approximately twenty percent (20%), is approximately thirty percent (30%) is approximately forty percent (40%), and/or is approximately forty-five percent (45%) of the total composition of the final product 204. The customer is able to select one or multiple urn types, provided that the size of a single urn utilizing all of the cremain material will result in substantially larger final products than will manufacturing many iterations of one or both urn types 206. The customer is informed that Oroboro urns can be biodegradable in nature and render seed growth 208 or as permanent keepsake urns 210. Once the type or types of urns has/have been chosen, the customer can proceed to selection of the number of editions of each type they want fabricated 212. At this point, the customer is presented with form selection options for their single or multiple urn types 216.

Should the customer choose from a set of pre-designed forms 218, the customer has the option to select photorealistic forms, such as figures related to sports, animals, or religious symbols 220. Alternatively, the customer can choose from sets of abstracted or generative forms, such as platonic solids, intersections of solids and generative motifs, as well as forms similar to that of fractals or natural phenomena 222. The Oroboro-trained designer or technician enters the appropriate information into the modeling/form generation software. This information includes the number of iterations and estimated volume of the cremain material, as well as relevant or sentimental dates or numbers that can parametrically customize the final dimensions of the form without having to manually alter the digital model 224. The final form is then ready for any final surface customization 226.

For customers choosing a custom modeled form, the process 228 differs slightly. The cost to produce custom models adds to the final price to manufacture the Oroboro urn. Photorealistic forms can be modeled after anything, from images to the deceased themselves, or forms relevant to the customer and their family 230. Conversely, more abstract forms 232 can be generated and modeled to be more sculptural or artistic in form and motif. Similarly to the process of deriving models from pre-designed forms, the customer can provide personally significant numerical values if they desire to alter or determine the final form of the custom model with the aid of the parametric design software 234, explained in further detail in FIG. 3. Once this information has been provided, additional and final modeling is completed 236, and the form is then ready for any final surface customization.

Once the final form has been modeled, the customer has the option to add embossing or engraving to the final design. Such patterns can include a name, a passage, a coat of arms, or any other graphic 238. The customer is then presented with a final rendering or visual mockup of the urn(s) that will be printed 240. When the customer signs off on the model design, the final form is then generated and exported as a supported file format (an OBJ or STL mesh format, for example) that model slicing software for printers can successfully import 242. Once imported into additional slicing software, the appropriate code is generated for the type of printer or 3D extrusion implement and exported into the correct machine readable format 244.

Referring to FIG. 3, the Oroboro process relies on the customizability of the product, which can be accomplished with the use of existing proprietary modeling software and open source plugins or custom written software. The diagram depicted in FIG. 3 represents the software process and user journey for the Oroboro urn fabrication software. However, the modeling of the actual urn can also be accomplished in modeling software similar to and/or including Autodesk's Maya or McNeil's Rhinoceros; plugins like the graphical interface Grasshopper and its ecosystem of modules further facilitate the parametrization of the design process. These programs' compatibility with languages like Python and C# allow for those skilled in the field of programming or computational design to write custom scripts or programs (sets of instructions) to be used for custom form generation by designers and technicians modeling Oroboro urns. The concept for custom Oroboro software mentioned above is another alternative to using existing software; it consolidates the different features that span across different types of sales, modeling, parametric design, and file formatting software into one program for Oroboro technicians and vendors to operate. Once the customer intake process is complete, a skilled technician opens the software to the welcome portal 302, on either a web platform or a desktop platform. The user signs in 304 and, upon doing so, is redirected, for example, to their index listing all past sales and generated and printed models 306.

The Oroboro technician then chooses which process the customer has chosen from for development. If the customer has chosen to use a pre-modeled form 308, the user is directed to a visual list of models from which they may choose. Once the particular model has been chosen, the technician must enter the approximate volume of the cremain particulate, as well as the final volume of the ash and composite mixture that will be used for that particular urn edition 312. If the customer or deceased had a favorite number or wished to incorporate a numerical birth date into the urn, these numbers can be added in a custom configuration step that determines directional measurements such as height, width, length, or, for example, rotation of the model around an axis 314. This offers the customer the option to add a personal touch to the urn, despite having selected the original form from a pre-modeled list. The technician is then able to update the model with the new optional parameters and generate the final pre-made form 316.

In the event that the customer wishes to develop a custom-modeled urn 318, a technician skilled in 3D modeling begins by creating a new digital modeling workspace 320. Just as with the pre-modeled route, the technician first enters volumetric measurements based on the ash and composite particulate 322. In the custom modeling process, optional numerical parameters 324 can affect greater overall change on the final form of the model. As there is more flexibility in the design process, it is up to the customer to decide how complex and how many extra parameters they would like to manipulate. For example, a technician could create an urn out of the intersection of a sphere and a honeycomb motif. If the customer is partial to the number “16,” and the date “12-03-92,” these numbers could be entered to determine different customizable parameters, such as the diameter of the sphere (12 cm in this example), the honeycomb could have 92 hexagonal units measure the surface and measure 3 cm in diameter, while the whole structure could measure 16 cm in length. These are all arbitrary numbers that serve to illustrate how the Oroboro software facilitates overall customization of the Oroboro urn without material waste associated with custom burial implements that serve merely as containers. Finally, the model is either procedurally generated or manually modeled if the customer desired a more photorealistic design 326. The model is then ready for the final stage of customization.

Once a model has been completed, the customer has the option to add custom or pre-modeled text or graphics to be printed or cast as a raised or embossed texture 328. An example of such a graphic could include dates, bible passages, or logos of a beloved sports team. The model then undergoes a manual and automated check by printing software to ensure that there are no parts of the model that have poor structural integrity or are susceptible to breakage during and/or after printing 330. Should a flaw be found in the model of the urn, the technician edits the model until it passes inspection by the printing software, which is then exported 332 to a mesh file type, such as an .OBJ or .STL file that can be read by all common model slicing software such as Slic3r or Cura. If the technician is using external software like Slic3r, the urn model is imported into the program, where it is sliced into layers with a height that the intended printer can accommodate 334. For powder printing, the model will be sliced into layers measuring about 0.2 microns in thickness and between approximately 50 to 200 microns per layer for paste extrusion printers. Tool paths or predefined paths that the print head will travel are generated into code or a machine readable set of instructions 336. The Oroboro software consolidates this stage of the process as another step in the process of generating the urn for final fabrication. Once the instructions have been generated, they can be sent 338, e.g., through a network connection to a printer or can be transferred physically by loading the instructions onto an external storage device, such as a USB.

The concept for proprietary Oroboro software also accommodates the generation of sales estimates 340 based on the material volume and print time estimates that the software is able to generate. These are calculated by considering, for example, the speed of a respective print head, the number of layers per model, the length of each tool path, the volume of the added composite material, and the hours of technician labor tracked to generate and fabricate the Oroboro urn. The Oroboro technician is then able to generate a report or invoice 342, further consolidating an otherwise fragmented modeling and cost estimation process.

Referring to FIG. 4, the conceived process is best facilitated by software that consolidates the process spanning over multiple types of software to include only the most necessary functions. FIG. 4 depicts an exemplary interface that a user would interact with to accomplish the modeling and generation of an Oroboro urn or mold to submit to a printer. In the case of the Oroboro urn modeling process, the software concept covers the functions of parametric and generative modeling, form/mesh manipulation, structural deficiency monitoring, mesh slicing, G-code or printer tool-path generation, price/fabrication time estimation, and product management. The Oroboro software has a branded portal 402 that users are able to log into, to track, and to manage the modeling and fabrication process of the urn from start to finish. Technicians are directed to different pages or modals 404 to enter basic measurements as well as optional values to further customize the model. Recognizable preforms can be added from a list or uploaded from a file 406. Further, motifs, graphics, or text can be added to the model 408, which is generated and rendered for final approval 410. The interface also provides the user with valuable fabrication metrics like cost and print time that can be used to generate invoices 412.

Referring to FIG. 5, a fused deposition modeling of an Oroboro urn requires both the extrusion printer 502 as well as a second paste extrusion system 504 to control the flow of the wet cremain composite 506. Each batch of the composite is measured to ensure that extrusion will be complete before drying and that it is able to pass through a transfer channel to the print head 512 without blockage. The paste extrusion system 504 can comprise of a simple hopper, and the flow of material out is controlled by a motor acting like a plunger 508 that expels the material outward and into the material feed 510. The material 506 is transferred to the print head 512, where each layer is laid down to build the Oroboro urn 514. The speed of the print head depends on the rate of the extrusion as it is expelled from the material hopper. The type of printer depicted is a traditional FDM printer that moves the print head along an X-Y axis while the build platform 516 moves down in the Z direction as each layer is deposited. This is only one exemplary type of paste extrusion and others are equally possible as well. This process is extensible to a host of other types of FDM printing, so long as a print head or tool is able to move in the X, Y, and Z directions depositing layers of material. The fidelity of the printed urn is subject to the layer thickness that the each individual printer is able to achieve. Ultimately, vendors and fabricators may be able to retrofit existing FDM printers as well as to configure their own custom solution specifically designed and built for the fabrication of Oroboro urns at their facility.

FIG. 6 illustrates a powder printing fabrication of an Oroboro urn by either retrofitting or reconfiguring a traditional powder printer, similar to that of a Z Corp printer 602. This process is different than FDM or paste extrusion printing as the dry cremain composite material is loaded separately into a powder supply chamber 604, while the binder is loaded into a different binder supply chamber 606, similar to the way ink would be loaded into a traditional 2D printer. To print each layer of the urn 618, the powder feed piston 608 drives the bed of powder upwards to release just enough dry material for the leveling roller 610 to spread over the powder printing bed 612. The print head 616 moves along a rig 614 on the X, Y axis as is spreads binder over the powder bed 612 based on the tool paths to solidify that particular layer of the urn 618. As binder is moved through the binder feeder to the print head 616, the print head 616 will deposit the correct amount of binder to simply harden the particulate. However, the particulate is not stable until it is removed and the urn 618 is treated with a hardening agent. The hardening agent can be proprietary or from a commercial vendor, or made from a combination of approximately 1-10% glycerol, approximately 0-2% preservative, approximately 0-1% surfactant, approximately 0-20% pigment, and approximately 80-95% water. When the layer is finished, the build piston 620 drives the powder print bed 612 downwards just enough to accommodate the height of the next layer. When the process is complete, excess material is delicately removed or brushed off from the urn 618, and can be reused or recycled.

FIG. 7 illustrates a custom-printed biodegradable urn 514, 618 containing embedded seeds 702 at the top of the form. For forms of printing, the seeds 702 are added to the dry or wet particulate as the printer finishes the last 1 to 2 inches of the top of the urn 514, 618 that will be buried closest to the surface 802 of the earth. With respect to the casting of an Oroboro urn 514, 618, the seeds 702 are added after the wet cremain composite has been poured through a sprue in the mold.

FIG. 8 shows a cross-section of a buried biodegradable Oroboro urn 514, 618, which is buried close enough to the surface 802 of the earth to allow for proper seed growth. The distance between the top of the soil and the top of the urn 514, 618 should not exceed approximately four (4) inches. Furthermore, the environment in which the biodegradable urn is buried is not limited to an open outdoor space, it can be buried inside a covered structure. Oroboro urns vary in size as a hallmark of the customizability of the process and the product; as such, it is possible for biodegradable urns to be buried in pots, terrariums, or other alternative environments. The biodegradable urns are able to remain on a shelf or on display for a minimum of eighteen (18) months following fabrication, accommodating flexibility around the time frame in which the actual Oroboro urn is buried.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems, apparatuses, and methods. However, the systems, apparatuses, and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems, apparatuses, and methods as defined by the following claims.

What is claimed is:

1. A process for low waste production of funerary urns, which comprises:
providing cremain as a powder having a particulate size of between approximately 0.1 micron and approximately 1000 microns;
providing composite material as a powder having a particulate size of between approximately 0.1 micron and approximately 1000 microns;
placing the cremain and composite material into an input container of a 3D printer, wherein the composite material and the cremain are mixed to have at least approximately 20% by volume of the cremain;
generating a 3D printer input file corresponding to at least one urn shape; and
based upon the input 3D printer input file, printing the at least one urn shape from the mixture with the 3D printer.

2. The process according to claim 1, wherein the cremain is approximately thirty percent (30%) of the volume of the mixture.

3. The process according to claim 1, wherein the cremain is approximately forty percent (40%) of the volume of the mixture.

4. The process according to claim 1, wherein the cremain is approximately forty-five percent (45%) of the volume of the mixture.

5. The process according to claim 1, wherein the cremain is approximately fifty percent (50%) of the volume of the mixture.

6. The process according to claim 1, wherein the 3D printer comprises a wet paste extrusion system having:
a feed line;
the input container as a hopper in which is disposed the mixture of the composite material and the cremain and binder and that is fluidically connected to the feed line; and
a print head fluidically connected to the hopper through the feed line and carrying out the printing of the at least one urn shape.

7. The process according to claim 1, wherein:
the cremain is a first powder having a particulate size of between approximately 0.1 micron and approximately 200 microns;
the composite material comprises:
binder; and
a second powder having a particulate size of between approximately 0.1 micron and approximately 200 microns; and
the 3D printer comprises a dry powder printing system having the input container as:
a powder supply chamber in which is disposed the cremain and the second powder; and
a printer cartridge in which is disposed the binder.

8. The process according to claim 1, wherein the composite material comprises a biodegradable organic material and the at least one urn printed is biodegradable.

9. The process according to claim 8, wherein the organic material comprises dextrin-based glue.

10. The process according to claim 8, which further comprises adding at least one seed to the upper two inches of the urn.

11. The process according to claim 10, which further comprises burying the urn no deeper than four inches below the surface of the ground to permit growth of the at least one seed.

12. The process according to claim 1, wherein the composite material is selected from materials comprising at least one of clay, wood powder, plastic powder, silica or sand, stone particulate, and/or metal powder and the urn produced is a permanent keepsake.

13. The process according to claim 1, wherein the binder comprises a chemical binder selected from at least one of resin, collagen, casein, wax-based cement, and/or wax-based adhesive and the urn produced is a permanent keepsake.

14. The process according to claim 1, which further comprises coating at least an outside surface of the urn with a glaze.

15. The process according to claim 1, wherein the glaze is at least one of protein based and/or hydrophilic.

16. The process according to claim 1, wherein the glaze comprises at least one of ceramic glaze and/or a stain.

17. The process according to claim 1, which further comprises selecting at least one urn shape from a plurality of urn shapes.

18. The process according to claim 1, which further comprises selecting a plurality of urn shapes and repeating the generating, inputting, and printing steps for each urn shape.

19. The process according to claim 1, which further comprises:
selecting a plurality of urn shapes;
selecting the number of editions of each urn shape to be fabricated; and
repeating the generating, inputting, and printing steps for each edition of each urn shape.

20. The process according to claim 1, wherein the urn is one of a pre-designed form, a custom-designed form, and a photorealistic form.
